(19) United States
(12) Patent Application Publication
(10) Pub. No.: US 2017/0083680 A1
(43) Pub. Date: Mar. 23, 2017

(54) Method and System for Tracking, Storing, and Processing Data to Identify Risk Factors and Predict Health-Related Conditions

(71) Applicants: Andrew Adolphus, Brooklyn, NY (US); Jordan S. Rathus, Brooklyn, NY (US); Spencer A. Rathus, Surfside, FL (US); Lois Fichner-Rathus, Surfside, FL (US)

(72) Inventors: Andrew Adolphus, Brooklyn, NY (US); Jordan S. Rathus, Brooklyn, NY (US); Spencer A. Rathus, Surfside, FL (US); Lois Fichner-Rathus, Surfside, FL (US)

(21) Appl. No.: 15/166,157

(22) Filed: May 26, 2016

Related U.S. Application Data
(60) Provisional application No. 62/167,252, filed on May 27, 2015.

(51) Int. Cl. G06F 19/00; H04L 29/08

(52) U.S. Cl. CPC G06F 19/3431; G06F 19/3418; H04L 67/306

(57) ABSTRACT

A system and method are disclosed comprising a mobile platform that tracks and correlates user-generated data and application-sourced data to ascertain environmental and personal risk factors or causes related to a user's physiological and mental health symptoms and conditions. The mobile platform alerts users when risk factors or causes are identified and predicts occurrences of the symptoms and conditions. Further, the platform enables users to observe selected symptoms and health conditions within a chosen venue or geographic range or location, anonymously identify other users within that venue or range, and communicate with other users within a venue, range, or location. The venue or range may also be given a score that indicates the presence or prevalence of various symptoms or health conditions.

### CROSS-REFERENCE TO RELATED APPLICATION

The present application claims priority to U.S. Provisional Application Ser. No. 62/167,252, filed on May 27, 2015 and entitled “A Mobile Platform for Tracking, Storing, and Processing User-Generated and Application-Sourced Data to Identify Risk Factors for Health-Related Conditions and Predict Their Occurrence,” which is hereby incorporated by reference herein in its entirety, including any figures, tables, equations, or drawings.

### FIELD

The systems, devices, and methods disclosed herein relate generally to processing and analyzing data. More particularly, the systems, devices, and methods relate to tracking and predicting medical risk factors.

### BACKGROUND

Society is increasingly becoming more health conscious. Advances in science have identified some relationships between environmental factors and individual health risks in an individual's overall immediate and future health. As a result, individuals seek individualized information on health risks factors.

Various mobile platforms attempt to provide users with information regarding allergies, migraines, and other health conditions. Some allergy related applications use the Global Positioning System (“GPS”) and public records of pollen counts to alert users of possible allergic risks. Further, various online and mobile platforms allow users to search for relevant causes and diagnoses related to specific symptoms. Yet still other mobile platforms alert users to allergic reactions associated with various venues, such as restaurants. A problem in many of these systems is that they rely on the user to input information regarding the user's symptoms prior to providing notices of relevant diagnoses or risk factors. For an individual, it can be time consuming to input their medical information. Further, the user may not be aware of pertinent information to include. Although known mobile platforms can include diagnoses, such diagnoses can be generic and not tailored to the unique environmental and health risks of the user.

Accordingly, a need exits in the art for a system and method that requires minimal initial input from a user to receive individualized health-related notifications. A system is needed that automatically integrates user-generated data, including current physiological data, with data from service providers to generate notices concerning the causes or risk factors related to health conditions and predict health risks. It would be further advantageous for users to be able to communicate with other users with similar conditions in a given venue or geographic range or location.

Yet another problem with the various mobile platforms that attempt to provide users with information regarding health conditions is that each mobile platform utilizes a different interface. As a result, users are required to learn various different interfaces which can be difficult.

Accordingly, a need exists in the art for a common interface for a user to receive individualized information on health risks factors from various mobile platforms regarding health conditions.

### SUMMARY

A system and method for identifying risk factors and predicting health related conditions is provided. Unlike known systems that track for a specific health purpose (i.e., migraine-tracking, allergy-tracking, and food diary applications), the system and methods disclosed can track various types of symptoms, including but not limited to, migraines, allergies, moods, psoriasis flare-ups, acne, stress, seasonal affective disorder, sexual dysfunctions, gastrointestinal problems, insomnia, and other sleep disorders, such as nightmares. Users can either select from a predetermined list of symptoms or health conditions and/or input their own.

### BRIEF DESCRIPTION OF THE DRAWINGS

The detailed description makes reference to the accompanying figures wherein:

FIG. 1 illustrates an exemplary network diagram;

FIG. 2 is a block diagram depicting a computer system architecture for implementing the mobile platform in accordance with various embodiments;

FIG. 3 is a flowchart depicting an exemplary process according to the preferred embodiment;

FIG. 4 illustrates an exemplary graph of the information stored in a user profile in accordance with the preferred embodiment;

FIG. 5 illustrates an exemplary screen diagram showing a user interface; and

Other objects, features, and characteristics, as well as methods of operation and functions of the related elements of the structure and the combination of parts, will become more apparent upon consideration of the following detailed description with reference to the accompanying drawings.

### DETAILED DESCRIPTION

A detailed illustrative embodiment is disclosed herein. However, techniques, methods, processes, systems and operating structures in accordance with the disclosure may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure.

None of the terms used herein, including “terminal,” “one button,” “provider,” and “module” are meant to limit the application of the invention. The terms are used to illustrate the preferred embodiment and are not intended to limit the scope of the invention. Similarly, the use of these terms is not meant to limit the scope or application of the invention, as the invention is versatile and can be utilized in many applications, as will be apparent in light of the disclosure set forth herein. The following presents a detailed description of the preferred embodiment with reference to the figures.

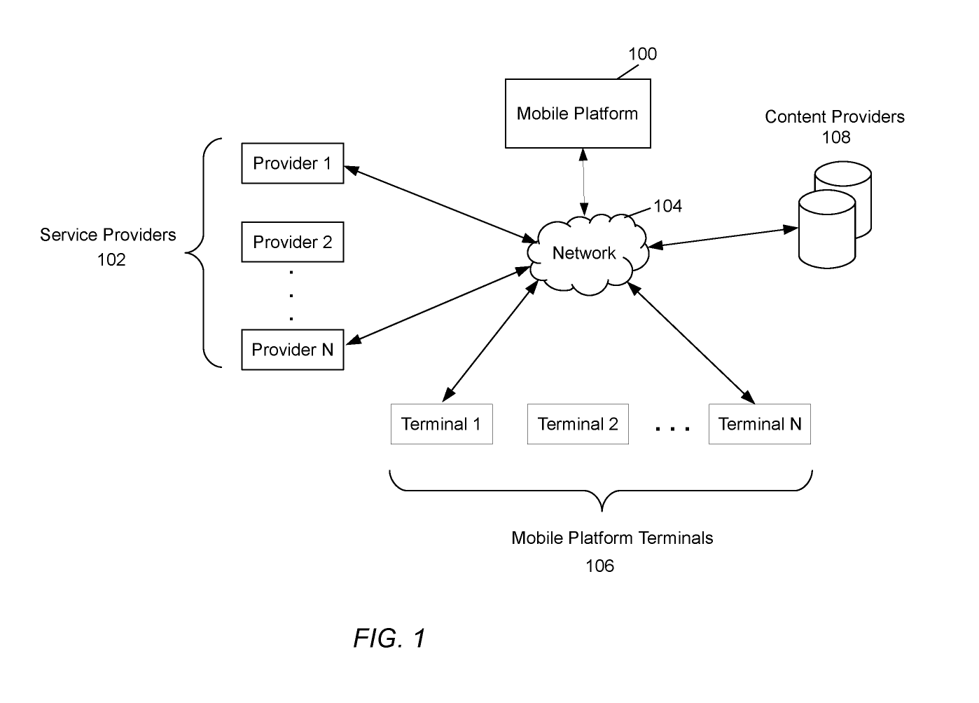

Referring initially to FIG. 1, shown is an exemplary network diagram of mobile platform 100. Mobile platform 100 can be implemented on hardware or a combination of hardware and software. In the preferred embodiment, the techniques disclosed herein are implemented in a software environment such as an operating system or in an application running on an operating system. This software can include, but is not limited to, resident software, firmware, etc., or is implemented on a cloud-based or visualized network system.

Mobile platform terminals 106 communicate over network 104 with mobile platform 100. Mobile platform terminals 106 are preferably configured to receive, process, store, and transmit information. The information can be visual, auditory, tactile (i.e., when a smartphone vibrates), or even olfactory, as when a device converts olfactory information into a digital format and transmits. Exemplary mobile platform terminals include, but are not limited to, a mobile telephone, cellular telephone, smart telephone, laptop computer, netbook, personal digital assistant (PDA), smart watches, optical head-mounted displays (OHMDs), smart clothing, smart refrigerators or any other computing device suitable for network communication.

Network 104 can be a local area network (LAN), a wide area network (WAN), the Internet, cellular networks, satellite networks or any other network that permits the transfer and/or reception of data to and/or from mobile platform 100. The data transmitted to or from mobile platform 100 through network 104 can be transmitted and/or received utilizing standard telecommunications protocol or standard networking protocol. In the preferred embodiment, the system utilizes Transmission Control Protocol/Internet Protocol (TCP/IP) and network 104 is the Internet. Other examples of protocols for transmitting and/or receiving data include but are not limited to Voice Over IP (VOIP) protocol, Short Message Service (SMS), and Global System for Mobile Communications (GSM). Network 104 is capable of utilizing one or more protocols of mobile platform 100. Furthermore, network 104 can translate to or from other protocols to one or more protocols of mobile platform terminals 106. Therefore, a user can seamlessly transition from one device to another and continue to track, store, and process data to identify risk factors and predict health-related conditions from mobile platform 100.

Service providers 102 communicate over network 104 with mobile platform 100. Health providers can use service providers 102 to communicate information on the services that they can provide to users on mobile platform terminals 106. Health providers comprise businesses and groups that could provide assistance to users after mobile platform 100 identifies a health risk or medical condition. Exemplary health providers include, but are not limited to, fitness clubs, emergency care providers, yoga studios, tea shops, stress relief programs, gluten free businesses, and medical specialists. In the present embodiment, a health provider creates a profile on mobile platform 100. The health provider profile can include a location, approved health insurance plans, and services provided by the health provider. Therefore, mobile platform 100 can recommend relevant health providers for risk factors and/or medical conditions identified for a user.

Mobile platform 100 can communicate over network 104 with content providers 108. Content providers 108 can include but are not limited to the U.S. Food and Drug Administration Recalls, Market Withdrawals, & Safety Alerts; Centers for Disease Control and Prevention; National Weather Service; National Centers for Environmental Information; the World Health Organization; and any other service that provides domestic and international health related news, alerts, and other information available through network 104. Further, mobile platform 100 can scrape the content of various websites, including but not limited to, a municipality web site. Thereafter, the information (e.g., local health related notices) can be utilized in addition to information from other content providers 108 when determining the notifications to send to users.

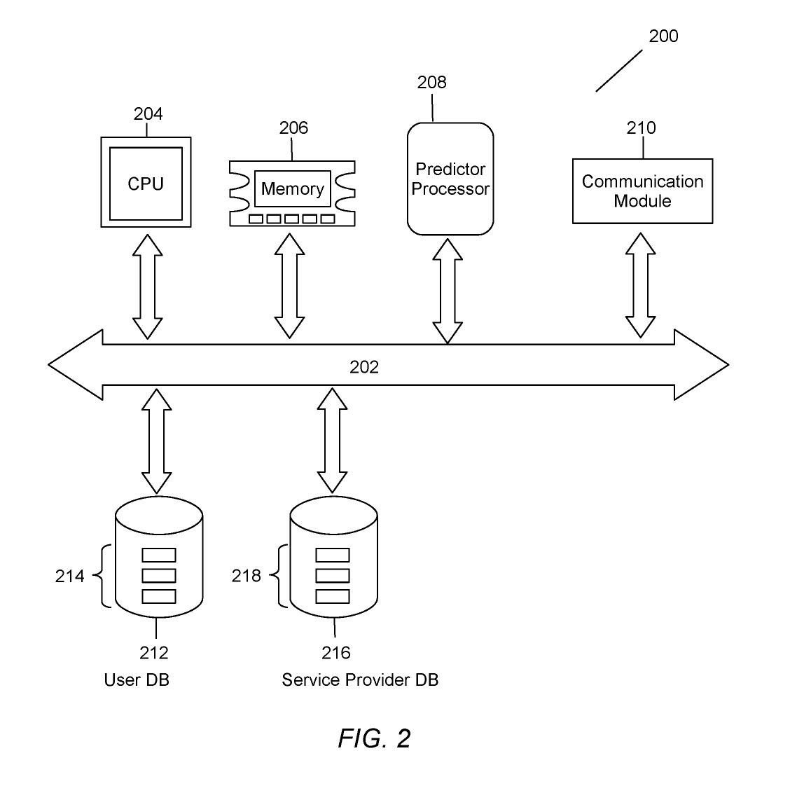

Referring now to FIG. 2, shown is an exemplary block diagram depicting a computer system architecture for implementing mobile platform 100. At least one computer processing unit (CPU) 204 is interconnected to bus 202. At least one memory 206 is interconnected to CPU 204 through bus 202. Communication Module 210 allows mobile platform 100 to communicate through a network with mobile platform terminals, service providers, and content providers.

The computer system architecture further includes at least one database. The databases described below can store data over one or multiple databases. In the preferred embodiment, user database 212 comprises at least one user profile 214. User profile 214 securely stores various information about a user, including but not limited to age, medical history, allergies, potential risk factors, and family medical history. The information stored in user profile 214 can be directly inputted by the user, or mobile platform 100 can predict the information using predictor processor 208. In the preferred embodiment, predictor processor 208 utilizes various weighted factors to determine the possible health risk factors.

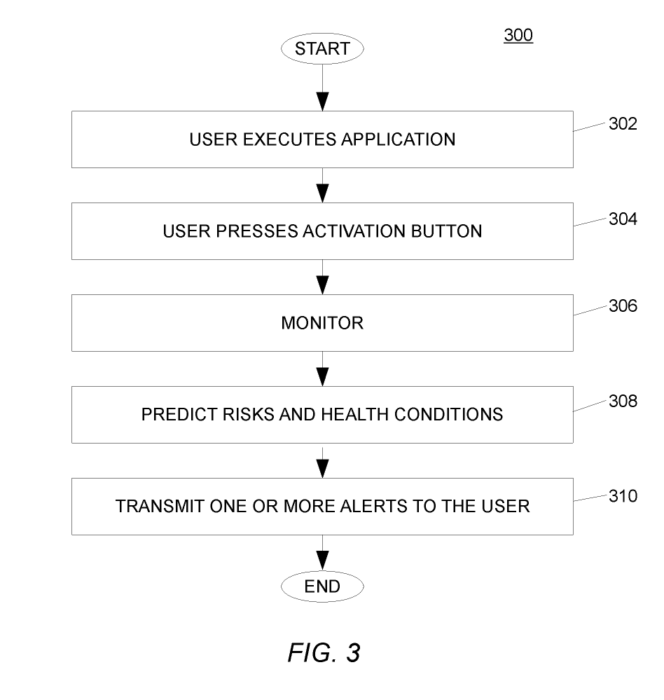

FIG. 3 depicts a flowchart 300 representing a user experience in accordance with the preferred embodiment. First, in step 302, the user downloads or executes an application on the user's mobile platform terminal. Unlike other similar applications, which require that the user input data prior to providing relevant information, the application in this embodiment has one single “button” that the user presses or touches upon the initial opening of the application. In step 304, the user presses the “button.”

Next in step 306, the mobile platform stores a timestamp in the user profile. Thereafter, the mobile platform monitors various sources of information, including but not limited to, user-selected (or later inputted) symptoms, environmental conditions, and application-sourced data. In step 308, the mobile platform predicts risk factors for a user profile based on the information monitored in step 306.

Thereafter, in step 310, the mobile platform notifies the user of the risk factors and health-related conditions identified in step 308. The data can be displayed in various ways, including pie charts, graphs, charts, maps, annotated maps, and maps displaying the locations of other users.

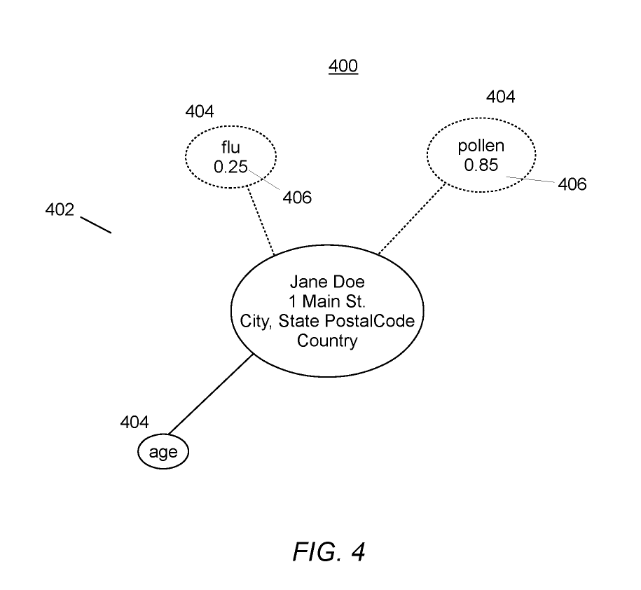

FIG. 4 depicts a graph 400 of exemplary information stored in a user profile of mobile platform 100. User profile 402 is for the user named “Jane Doe” located at the address: 1 Main St., City, State, Postal Code, Country. User profile 402 includes at least one user data element 404. User data elements inputted by the user are represented in solid lines. Here, the user has inputted their age. User data elements with dashed lines represent elements that predictor processor 208 of mobile platform 100 has predicted based on the available information. Each predicted user data comprises predictor index 406. In this embodiment, predictor index 406 represents the likelihood that a predicted user data element is present. Further, when the predictor index is equal to or exceeds a threshold value, mobile platform 100 can provide notification of a predicted user data that is a risk factor. While the value of predictor index 406 can vary between 0.01 to 0.99, it would be readily apparent to one of ordinary skill in the art to use various scales for the predictor index to represent the likelihood of the presence of a user data element.

As shown in FIG. 4, the predictor processor has predicted that there is a pollen risk for the user, although the user has not indicated the presence of pollen at their location. Mobile platform 100 can access content providers 108 and application sourced data (i.e., the user's location information) for information on the pollen levels at the user's current location. Further, as described below, mobile platform 100 can utilize the information of other user profiles to determine a correlation between allergic reactions to pollen within the user's current location.

Another object of the preferred embodiment is to utilize user-generated data. The user-generated data is preferably user-inputted data. Exemplary user-inputted data includes, but is not limited to, food/beverage consumption, duration and type of exercise, time spent at work and type of work, presence of insomnia, nightmares, other sleep disorders, current or chronic mood, stress level, tension, and associated autonomic nervous system activity, sexual activity and sexual dysfunctions, time spent in sedentary activities such as watching television and movies, chronic conditions such as cardiovascular disorders, diabetes, and respiratory disorders. The user can also specify at least one health condition of interest. This information can be inputted manually, or the user can select a health condition from a predetermined list of conditions. In one embodiment, the user can enter positive experiences and events. Thereafter, mobile platform 100 can notify the user of similar activities related to the positive experience and/or event.

While the mobile platform can identify risk factors and predict health-related conditions with minimal input from the user, in some embodiments, the speed of the analysis can be improved by the user providing user-generated data. Some user data can also be generated by continuous, continual, or intermittent assessment of physiological responses, as measured by wearable devices such as a smart watches.

Yet another object of the preferred embodiment is the use of application-sourced data to track the user's location by means such as GPS and triangulation or trilateration of the user's cellphone. Other application-sourced activity involves the accessing and tracking of local environmental data, including but not limited to elevation, weather (barometric pressure, temperature, cloud cover, humidity, wind, etc.), moon phases, pollen count, air-borne particulates, activity (time spent in motion or inactive), and phone usage. The mobile platform periodically updates the stored data. In one embodiment, the application-stored data can includes physiological responses such as heart rate collected from wearables.

The mobile platform preferably allows the user to submit and update symptoms and health conditions. The mobile platform processes any updates or additional submissions according to the information stored on the user profile. For example, a user can submit a migraine six months after loading the application. Thereafter, the mobile platform correlates all the stored application-sourced and user-generated data with the new submission. As a result, a relevant diagnosis concerning the user's new submission can be quickly generated.

In some embodiments, data may be stored on the mobile platform or remotely. In an embodiment where the data is stored remotely, the mobile platform preferably continually communicates with the remote database. Therefore, the amount of data stored for a user profile can be dynamically increased or decreased by adding or removing additional remote databases. In this embodiment, the user can seamlessly retrieve or access information stored on the mobile platform and/or the remote database.

The application can also automatically access the user's heart rate, blood pressure, galvanic skin response (GSR), and other physiological data by linking to a wearable computer, such as “chipped” clothing, a smart watch, or an optical head-mounted display (OHMD) having means for receiving, processing, storing, and transmitting data. These exemplary wearable devices and others can contact the user's skin to facilitate the measurement of physiological data.

The mobile platform analyzes the symptoms, user-generated data, and application-sourced data to identify risk factors and predict health-related conditions.

Another object of the preferred embodiment is to determine the cause or causes of, or risk factors involved in, various health conditions. The health conditions include, but are not limited to, migraines, headaches, allergic reactions, psoriasis outbreaks, depression and other mental health conditions, asthma and other respiratory disorders, seizures and other neurological disorders, sexual dysfunctions, and cardiovascular symptoms and disorders.

The application can also include a diary function in which the user indicates a point in time when an incident occurs. Thereafter, the mobile platform can mark the time and correlate the diary entry with all data related to the point in time (application-sourced data).

Further, the mobile platform can cross-reference and analyze all of the information related to the user profile (i.e. user-generated data and application-sourced data) to determine recurring instances of combinations of factors that may be influencing and/or causing a health condition.

In some embodiments, the mobile platform can alert the user to the possibility of various health conditions unknown to, or unsuspected by, the user. The mobile platform can do so by correlating user inputted symptoms with ongoing collection of physiological data and accessing of information about environmental conditions.

Based on the information the application has collected, the application may need some additional information to “fill in the blanks” for diagnosis of a certain health condition. When the application recognizes the need for additional information from the user, the application can request additional information from the user as to whether he or she is experiencing a given symptom or group of symptoms.

In one embodiment, the data collected by the mobile platform is shared anonymously with an online community, thereby allowing each user's data to be compared with other users' data to help predict future outbreaks within a given area or venue, and also to aid medical research, such as epidemiological research.

For example, the mobile platform can permit users to observe that certain venues, neighborhoods, cities, or selected geographic ranges are dense with certain health conditions, whereas others are not. Users can be alerted when others in their area have indicated that they are experiencing an outbreak of a shared health condition. In one embodiment, a user can access a map showing locations/instances of other users with similar health conditions. Each data point can be marked as a dot on the user's display. Further, the dots can be differentiated using color coding to identify multiple heath conditions that the user is tracking.

In an exemplary display method, the user can decrease or enlarge the size of the geographic area covered by the display by compressing or spreading the display with the user's fingers. When the user makes the items on the screen smaller, thereby focusing on a larger area, the dots may merge. When the user enlarges a specific area, for example by spreading fingers on the screen, the dots can be displayed discrete. A user can interpret a concentration or density of health conditions as a risk factor for the health problem that has been listed and whose instances are being displayed. While the concentration of various users with similar health conditions in an area may not in itself reveal cause and effect, the mobile platform allows users to decide whether or not to frequent locations with a high density of their health problem.

Users can communicate with other users within the online community who may be experiencing similar symptoms or health conditions. The user can contact another user of the application by, for example, touching a dot on his or her display. Various possibilities for communication are possible. In one embodiment, a window can open for texting. In some embodiments, a user may send an email or transmit messages simultaneously to all users within the geographic location or venue shown on the display. When a message is sent, the user's profile or a part thereof, such as a photo, may accompany it. The user receiving the profile can in turn send their profile. The possible color-coding for a plurality of health conditions can also convert to meta-data that indicates which health condition the user is addressing. Other users—in this case, recipients of messages—can set their devices to accept or not accept messages from other users. Openness to reception of messages can be set as permanent unless changed, or to apply within a certain time frame or at a given location. Further, users can also block messages from a particular user, but the recipient would remain as a dot on the user's display. In this embodiment, the anonymity of a user is preserved unless the user decides to reveal their identity, photo, or certain kinds of demographic and profile information. Although one user may, for example, text another when a window for texting opens, the texting user would not know the phone number of the recipient. However, nothing prevents the users from exchanging contact and other information when windows of communication have been opened.

It may also be the case that those whose dots are displayed can be considered “followers” of the user, enabling the user to “tweet” or otherwise transmit messages to the grouping. The radius of the pool of recipients could be determined by the mobile platform or by the user.

Users can observe that persons with certain health problems are or are not likely to frequent certain restaurants. In one embodiment, the mobile platform can generate a screen that displays a summary of health issues afflicting users that frequent a restaurant. Based on the health profiles of users that utilize the mobile platform, users may be able to observe restaurant scores for allergies and migraines.

When users enter a condition, such as a current migraine, they can observe a recent map of their movements, barometric pressure, humidity, and so on. It may also be possible to enter dietary information, and the application can arrive at a solution in which it informs the user that he or she is most likely to experience a migraine when he or she has been in a certain neighborhood, in a certain type of weather, has eaten Chinese food or drunk red wine, and so forth.

The system and method disclosed herein are not limited to use by individual users. For example, the system can also be used for epidemiological research by health professionals. Health professional can use the information collected by the mobile platform to track neighborhoods or other venues that are associated with various health problems, the time of day that these problems are most pervasive, the barometric pressure, and pollen counts.

Further, some information collected by the mobile platform can be sold to various venues, such as stadiums, means of mass transportation, institutions, buildings, and restaurants. Restaurant owners, for example, may wish to know how their restaurant scores according to certain health factors in order to determine steps to improve their scores—for example, modifying the menus or physical environment—and become more attractive to their patrons.

In one embodiment, the mobile platform can be used to alert users when user-generated data and application-sourced data, including environmental data, predict the occurrence of a health condition such as an allergic response or a migraine headache. For example, the application may predict the occurrence of a migraine based on the user's location (GPS), recent alcohol intake, barometric pressure, ambient temperature, and the prevalence of the presence of other users with migraines. The user may also enter prodromal symptoms and rate their severity. In another embodiment involving wearable assessment devices, such as a smart watch, input variables such as heart rate, blood pressure, and galvanic skin response can also be used in the predictive matrix.

An embodiment of the mobile platform can be used to enable users to observe the prevalence of given symptoms and health conditions within a chosen venue, geographic range, or location (GPS). For example, users can observe whether other users are experiencing those symptoms and health conditions within the venue, range, or location. As a result, users may thus plan walking or other modes of travel routes that evade or circumscribe areas that are densely populated with individuals with the given symptoms and health conditions.

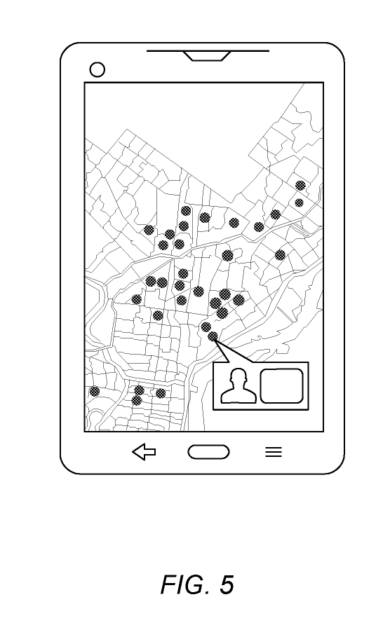

In another embodiment, the present invention can be used to enable users to select and communicate with other users in an area with similar symptoms or health conditions. In one embodiment shown in FIG. 5, other users are displayed as “dots” or similar entities on the user's display. By touching a given dot, a window for sending a message may be opened. In this embodiment, users can communicate only with other users with similar symptoms or health conditions. In initiating communication, the user may transmit some profile information such that the recipient can determine whether or not to respond to the message. Such profile information may be limited to a photo or may be as extensive as some social networking profiles. If the recipient responds, the recipient can transmit profile information.

An embodiment of the mobile platform can be used to enable users to transmit information concerning symptoms and health conditions, or venues in which these symptoms and health conditions are aggravated, to other users in the area. For example, users with food allergies could enable an alert that a given restaurant uses monosodium glutamate (“MSG”).

In one embodiment, the mobile platform can be used to compile for users a list of venues that are likely or unlikely to aggravate certain symptoms and health conditions based on the history of users' identification of such venues as locations in which their symptoms or health conditions appeared. These venues could appear on the user's display along with the display of other users who report given symptoms or health conditions. This embodiment can be used to compile scores for businesses or venues in an area based on user reports of, for example, aggravation of food allergies, other allergies, or migraines connected with proximity to or time spent within those businesses or venues. Businesses or venues can purchase information compiled by users as to the experiences they broadcast to other users. As described above, restaurant owners, for example, may wish to know how their restaurant scores according to certain health factors in order to determine steps to improve their scores—for example, by modifying the menus or physical environment—and become more attractive to their patrons. Exemplary user reports can be presented as anecdotal, numerical, or both. In this embodiment, the communications between individual users are not available.

In another embodiment, the principles disclosed herein can be used in medical/epidemiological research. For example, researchers can analyze neighborhoods or other venues associated with targeted health problems to compare environmental factors (temperature, barometric pressure, pollen counts, and the like) and summaries of user-generated data (age, gender, reported symptoms, BMI, blood pressure, and the like).

While the preferred embodiment has been set forth in considerable detail for the purposes of making a complete disclosure of the invention, the preferred embodiment is merely exemplary and is not intended to be limiting or represent an exhaustive enumeration of all aspects of the invention. It will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A computer-implemented method comprising the steps of:
storing in a database a user profile, the user profile including at least one user data element;
monitoring at least one content provider;
predicting at least one risk factor; and
sending a notification comprising the at least one risk factor.

2. The computer-implemented method of claim 1, wherein the step of predicting the at least one risk factor comprises:
accessing information from the at least one content provider;
accessing at least one user generated information; and
correlating the information from the at least one content provider and the at least one user generated information.

3. The computer-implemented method of claim 2, further comprising the step of assigning a predictor factor to the at least one risk factor.

4. The computer-implemented method of claim 3, further comprising the step of assigning a value to the predictor factor between 0.01 to 0.99.

5. The computer-implemented method of claim 4, further comprising the steps of:
comparing the predictor factor of the at least one risk factor to a threshold value; and
sending a notification comprising the at least one risk factor comprising a predictor factor greater than the threshold value.

6. The computer-implemented method of claim 1, further comprising the step of displaying at least one user profile with a substantially similar medical condition.

7. The computer-implemented method of claim 6, further comprising the steps of:
displaying a map wherein a plurality of user profiles with a substantially similar medical condition are indicated with a dot;
selecting a dot; and
viewing a user profile with a substantially similar medical condition.

8. The computer-implemented method of claim 3, further comprising the step of:
allowing users with a substantially similar medical condition to communicate.

9. The computer-implemented method of claim 1, further comprising the steps of
calculating a user location; and
recommending a service provider proximate to the user.

10. The computer-implemented method of claim 9, wherein the step of calculating a user location comprises utilizing a Global Positioning System.

11. The computer-implemented method of claim 10, further comprising the step of collecting physiological data utilizing a wearable device.

12. The system of claim 1, wherein the mobile platform comprises:
a CPU;
at least one memory;
a predictor processor;
a communication module;
at least one user profile database comprising at least one user profile; and
at least one service provider database comprising at least one service profile;
wherein the predictor processor is configured to predict at least one risk factor for the at least one user profile.

13. The system of claim 12, wherein the communication module is configured to communicate through the network a notification to the at least one mobile platform terminal comprising the at least one risk factor.

14. The system of claim 12, wherein the user profile comprises at least one user data element comprising a predictor index.

15. The system of claim 14, wherein the predictor index comprises a value between 0.01 to 0.99.

16. A system comprising:
a mobile platform;
a network;
at least one content provider;
at least one mobile platform terminal;
at least one service provider;
wherein the mobile platform communicates a notification to the at least one mobile platform comprising a risk factor.

17. A computer-implemented method, in a computer having a processor and a memory coupled to the processor, comprising:
monitoring a plurality of user profiles comprising at least one user data element;
monitoring at least one content provider;
predicting at least one risk factor by correlating information received form the at least one content provider and information received from the plurality of user profiles;
generating a notification to the plurality of user profiles comprising the at least one risk factor.

18. The computer-implemented method of claim 17, wherein the at least one risk factor is a substantially similar medical condition of the plurality of user profiles.
